(19) United States
(12) Patent Application Publication
(10) Pub. No.: US 2010/0238302 A1
(43) Pub. Date: Sep. 23, 2010

(54) PRINT INSTRUCTION APPARATUS AND PRINTING SYSTEM

(75) Inventor: Makoto Oyanagi, Matsumoto-shi (JP)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: SEIKO EPSON CORPORATION, Shinjuku-ku (JP)

(21) Appl. No.: 12/725,393

(22) Filed: Mar. 16, 2010

(30) Foreign Application Priority Data
Mar. 18, 2009 (JP) 2009-066592

(51) Int. Cl. H04N 5/225; G06F 3/12

(52) U.S. Cl. 348/207.2; 358/1.15; 358/1.18; 348/E05.048

(57) ABSTRACT

A print instruction apparatus is connected to a storage medium where an image file having image data contained therein is stored, and instructs a printing device to print an image selected by a user using a given communication standard. In the print instruction apparatus, when a set file in which directly accessible top image data and subsequent image data are contained is stored in the storage medium, wherein the subsequent image data is accessible at an address determined with an offset from a given position of the top image data as the origin, the offset being registered in a header of the top image data, an image ID configured to individually identify each piece of image data contained in the set file is set by analyzing the set file, and a list in which the set image ID and positional information based on the registered offset for reading the corresponding image data are contained so as to be associated with each other is created

### BACKGROUND

1. Technical Field

The present invention relates to a print instruction apparatus and a printing system. More particularly, the invention relates to a print instruction apparatus that is connected to a storage medium where an image file having image data contained therein is stored, and that instructs a printing device to print an image selected by a user, using a given communication standard, and to a printing system including the print instruction apparatus and a printing device that accepts image data from the print instruction apparatus and prints an image, wherein the printing device and the print instruction apparatus are connected so as to be able to communicate with each other using a given communication standard.

2. Related Art

As such a type of print instruction apparatuses, there have been proposed digital cameras that can provide an instruction for so-called direct printing, which transmit image data selected by a user from a plurality of pieces of image data stored in a memory card or the like to a printer and cause the printer to print the image data using, for example, PictBridge as a communication standard (e.g., see JP-A-2007-257609).

With the print instruction apparatus mentioned above, for example, supposing that a plurality of pieces of image data that are related to one another are contained in individual image files as in the case of images taken for panoramic composition, if the plurality of pieces of image data are not related to one another, there is a possibility that they are not displayed in succession on a monitor during image selection. In this case, the performance of search for image data by a user is impaired. As a result, print instruction cannot be smoothly provided. It will therefore take much time to perform printing.

### SUMMARY

An advantage of a print instruction apparatus and a printing system according to some aspects of the invention is that a plurality of pieces of image data that are related to one another are collectively managed, and a print instruction in conformity with a given communication standard is performed, thereby enabling smooth printing.

In order to achieve the above advantage, the following measures have been adopted in the print instruction apparatus and the printing system according to some aspects of the invention.

In a print instruction apparatus according to an aspect of the invention that is connected to a storage medium where an image file having image data contained therein is stored, and that instructs a printing device to print an image selected by a user using a given communication standard, when a set file in which directly accessible top image data and subsequent image data are contained is stored in the storage medium, the subsequent image data being accessible at an address determined with an offset from a given position of the top image data as the origin, the offset being registered in a header of the top image data, an image ID configured to individually identify each piece of image data contained in the set file is set by analyzing the set file, and a list in which the set image ID and positional information based on the registered offset for reading corresponding image data are contained so as to be associated with each other is created; when selection by a user of image data contained in the set file is accepted, an image ID set for the image data of the selection is acquired from the created list, and the acquired image ID is transmitted to the printing device, the acquired image ID being included in a command requesting start of printing; and when a command requesting output of image data corresponding to the image ID is received from the printing device that has received the command requesting start of printing, the positional information based on the offset that is associated with the image ID is acquired from the created list, and on the basis of the acquired positional information, the corresponding image data is read from the stored set file and is transmitted together with a data transmission command to the printing device.

Regarding the print instruction apparatus according to the aspect of the invention, a set file in which directly accessible top image data and subsequent image data are contained is considered. The subsequent image data is accessible at an address determined with an offset from a given position of the top image data as the origin. The offset is registered in a header of the top image data. In the print instruction apparatus according to the aspect of the invention, when the set file is stored in a storage medium, an image ID configured to individually identify each piece of image data contained in the set file is set by analyzing the set file, and a list in which the set image ID and positional information based on the registered offset for reading the corresponding image data are contained so as to be associated with each other is created. When selection by a user of image data contained in the set file is accepted, an image ID set for the selected image data is acquired from the created list, and the acquired image ID, which is included in a command requesting start of printing, is transmitted to the printing device. When a command requesting output of image data corresponding to the image ID is received from the printing device that has received the command requesting start of printing, the positional information based on the offset that is associated with the image ID is acquired from the created list, and on the basis of the acquired positional information, the corresponding image data is read from the stored set file and is transmitted together with a data transmission command to the printing device.

In this way, if a plurality of pieces of image data that are related to one another are organized so as to be contained in one set file, exchanges of commands and image data in conformity with a given communication standard can be performed between the print instruction apparatus and the printing device using, as a key, an image ID set for each image data. Since the offset associated with the image ID is contained in the list, image data can be smoothly accessed without analyzing the set file so as to acquire the offset every time the image data is accessed. As a result, a plurality of pieces of image data that are related to one another are collectively managed, and a print instruction in conformity with a communication standard is performed, thereby enabling smooth printing.

The term “given communication standard” as used herein includes PictBridge and the like.

In the print instruction apparatus according to the aspect of the invention described above, the offset from the given position may be converted to an offset from a starting address of the top image data and is contained in the list. This enables desired image data in the set file to be rapidly accessed.

In the print instruction apparatus according to the aspect of the invention, the set file may be a file in which a data format for every piece of image data contained in the image file is registered in the header of the top image data, and when the selection by the user of image data contained in the set file is accepted, the header of the top image data of the set file may be analyzed, and a data format of the image data whose selection is accepted may be transmitted in such a way that the data format is included in the command requesting start of printing. In this way, an image ID and a data format of image data can be associated with each other. This allows the printing device to perform printing even if the printing device does not support a set file.

Further, in the print instruction apparatus according to the aspect of the invention, the list may be created when establishment of communication is confirmed. In this way, the list can be created at an appropriate timing.

A printing system according to another aspect of the invention includes a print instruction apparatus that is connected to a storage medium where an image file having image data contained therein is stored, and that instructs printing of an image selected by a user; and a printing device that accepts image data from the print instruction apparatus and prints an image, the printing device and the print instruction apparatus being connected so as to be able to communicate with each other using a given communication standard. In the print instruction apparatus, when a set file in which directly accessible top image data and subsequent image data are contained is stored in the storage medium, wherein the subsequent image data is accessible at an address determined with an offset from a given position of the top image data as the origin, the offset being registered in a header of the top image data, an image ID configured to individually identify each piece of image data contained in the set file is set by analyzing the set file, and the list in which the set image ID and positional information based on the registered offset for reading corresponding image data are contained so as to be associated with each other is created; when selection by a user of image data contained in the set file is accepted, an image ID set for the image data of the selection is acquired from the created list, and the acquired image ID is transmitted to the printing device, the acquired image ID being included in a command requesting start of printing; and when a command requesting output of image data corresponding to the image ID is received from the printing device that has received the command requesting start of printing, the positional information based on the offset that is associated with the image ID is acquired from the created list, and on the basis of the acquired positional information, the corresponding image data is read from the stored set file and is transmitted together with a data transmission command to the printing device.

Regarding the print instruction apparatus in a printing system according to this aspect of the invention, a set file in which directly accessible top image data and subsequent image data are contained is considered. The subsequent image data is accessible at an address determined with an offset from a given position of the top image data as the origin. The offset is registered in a header of the top image data. In the print instruction apparatus in the printing system according to this aspect of the invention, when the set file is stored in the storage medium, an image ID configured to individually identify each piece of image data contained in the set file is set by analyzing the set file, and the list in which the set image ID and positional information based on the registered offset for reading corresponding image data are contained so as to be associated with each other is created. When selection by a user of image data contained in the set file is accepted, an image ID set for the selected image data is acquired from the created list, and the acquired image ID, which is included in a command requesting start of printing, is transmitted to the printing device. When a command requesting output of image data corresponding to the image ID is received from the printing device that has received the command requesting start of printing, the positional information based on the offset that is associated with the image ID is acquired from the created list, and on the basis of the acquired positional information, the corresponding image data is read from the stored set file and is transmitted together with a data transmission command to the printing device.

In this way, if a plurality of pieces of image data that are related to one another are organized so as to be contained in one set file, exchanges of commands and image data in conformity with a given communication standard can be performed between the print instruction apparatus and the printing device using, as a key, an image ID set for each image data. Since the offset associated with the image ID is contained in the list, image data can be smoothly accessed without analyzing the set file so as to acquire the offset every time the image data is accessed. As a result, a plurality of pieces of image data that are related to one another are collectively managed, and a print instruction in conformity with a communication standard is performed, thereby enabling smooth printing.

### BRIEF DESCRIPTION OF THE DRAWINGS

The invention will be described with reference to the accompanying drawings, wherein like numbers reference like elements.

FIG. 1 is a block diagram showing a schematic configuration of a printing system.

FIG. 2 is an explanatory view showing an example of an image file stored in a flash memory.

FIG. 3 is a sequence view schematically showing communication procedures in the printing system.

FIG. 4 is an explanatory view showing an example of a “StartJob” command.

FIG. 5 is a flow chart showing an example of an image list creation processing routine.

FIG. 6 is an explanatory view showing an example of an image list.

FIG. 7 is a flow chart showing an example of an image data reading processing routine.

FIG. 8 is an explanatory view showing an image list of a modification.

### DESCRIPTION OF EXEMPLARY EMBODIMENTS

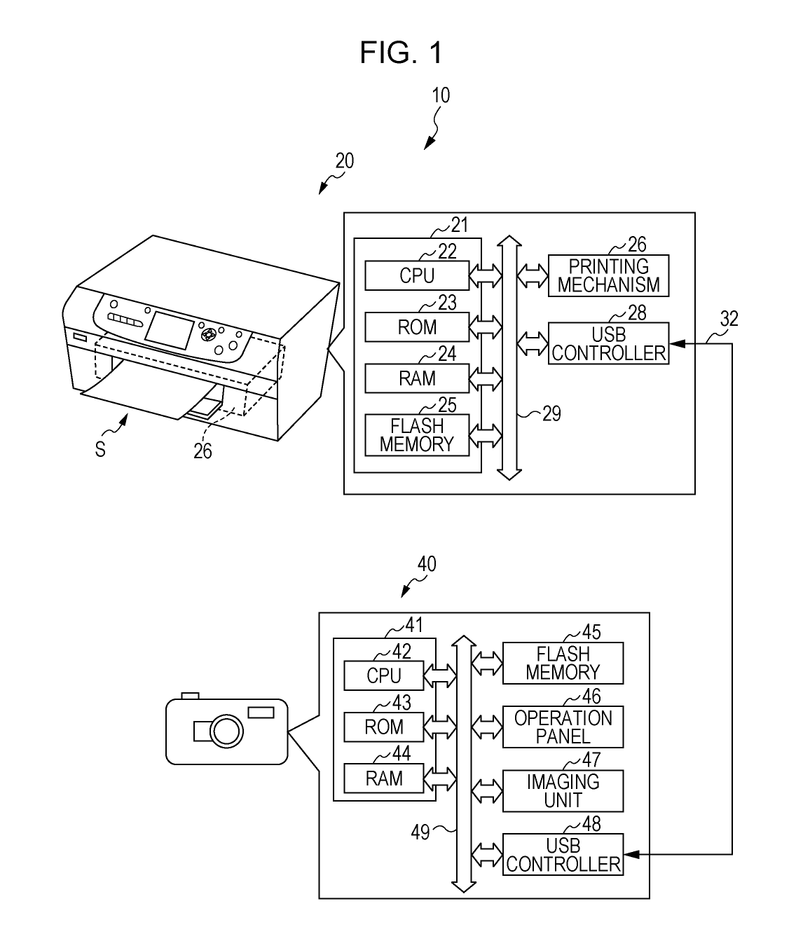

An embodiment of the invention is now described with reference to the accompanying drawings. FIG. 1 is a block diagram showing a schematic configuration of a printing system 10 made up of a digital camera 40, which is an embodiment of a print instruction apparatus according to some aspects of the invention, and a printer 20. In the printing system 10, the printer 20 and the digital camera 40 are connected so as to be able to communicate with each other via a universal serial bus (USB) cable 32 using PictBridg as a communication standard.

The printer 20 includes a controller 21 that is in charge of control of the whole device, a printing mechanism 26 that performs a process of printing an image onto a sheet of recording paper S, and a USB controller 28. Signals can be input and output between the USB controller 28 and an external device connected to a USB terminal (not shown). The controller 21 is configured as a microprocessor mainly made up of a central processing unit (CPU) 22, and includes a read only memory (ROM) 23 that stores various processing programs, a random access memory (RAM) 24 that temporarily stores data, and a flash memory 25 in which data can be written and erased. The controller 21 is connected via a bus 29 to the printing mechanism 26 and the USB controller 28. In the ROM 23, an application program for performing direct printing in conformity with the PictBridge standard is stored. Therefore, using the application program, the controller 21 can exchange various information with the external device connected to the USB terminal and print an image onto the sheet of recording paper S. Note that the printing mechanism 26, which is not shown, is a mechanism used in an ink jet method that performs a printing process by applying pressure to each ink, and discharging this ink onto the sheet of recording paper S.

The digital camera 40 includes a controller 41 that performs various types of control, an operation panel 46 that can display various information and allow input of a user's instruction, an imaging unit 47 that converts light incident through a lens into electrical signals by photoelectric conversion using an imaging device so as to generate an image file, a flash memory 45 in which the image file generated in the imaging unit 47 can be written and erased, and a USB controller 48 that allows input and output of signals from and to an external device connected to a USB terminal (not shown). The controller 41 is configured as a microprocessor mainly made up of a CPU 42, and includes a ROM 43 that stores various processing programs, and a RAM 44 that temporarily stores data and saves data. The controller 41 is connected via a bus 49 to the flash memory 45, the operation panel 46, the imaging unit 47 and the USB controller 48. In the ROM 43, an application program for performing direct printing in conformity with the PictBridge standard is stored. Therefore, using the application program, the controller 41 can exchange various information with the external device connected to the USB terminal and provide an instruction for direct printing.

Here, the image file generated in the imaging unit 47 of the digital camera 40 is one of two kinds a typical file in which one image is organized in a typical data structure, or a set file in which a plurality of images that are related to one another are organized in a data structure in a set format. The set file as used herein is generated, for example, in cases where, when a panoramic image capturing mode is selected by a user's operation on the operation panel 46 and a plurality of individual images that are to form a panoramic composite image are taken, the individual images are collectively accommodated.

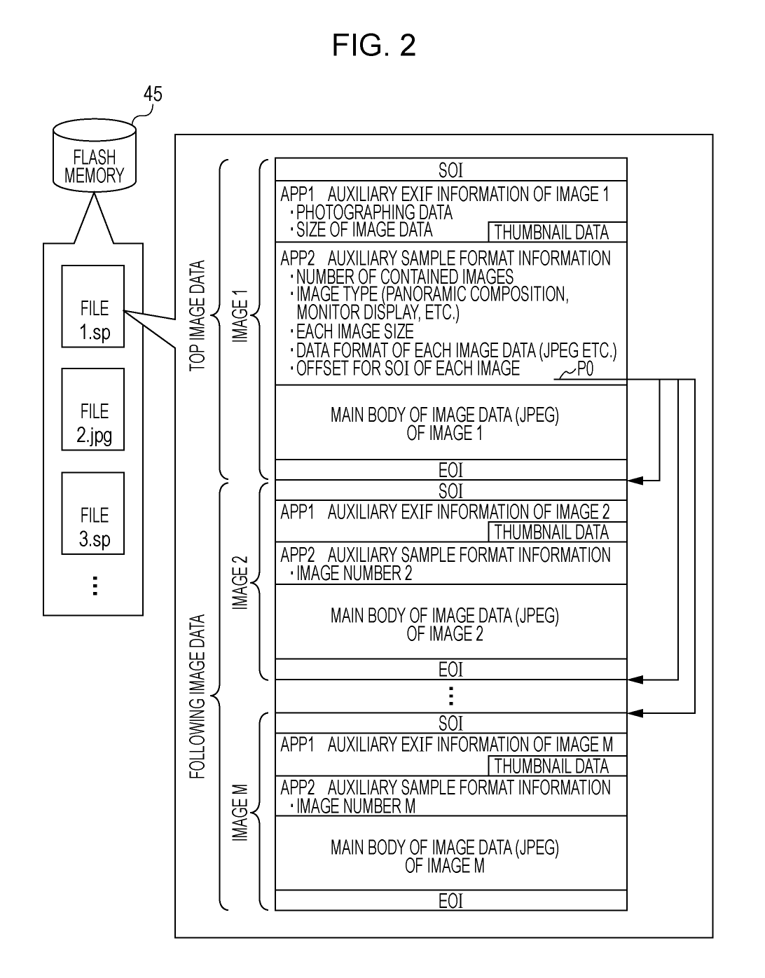

FIG. 2 is an explanatory view showing an example of an image file stored in the flash memory 45. A file 2 is a typical file in which images are encoded in a JPEG format, and is provided with “jpg” as the extension. The file 2 is made up of start of image (SOI) that is a marker indicating the top of data, a marker segment APP1 in which auxiliary exchangeable image file format (Exif) information that is information on an image and includes photographing data, such as a photographing date and an aperture value, the size of image data, and so on, and thumbnail data of a thumbnail image obtained resizing the original image data encoded in a JPEG format to a given size are recorded, and end of image (EOI) that is a marker indicating the end of the data, which are not shown. On the other hand, a file 1 and a file 3 are set files in which a plurality of images are contained such that they are organized as the top image data and subsequent image data that is dependent on the top image data in a data structure of a set format. In this embodiment, such a file standard is referred to as a “sample format” and is provided with “sp” as the extension. Note that the name and extension are illustrative, and the name and extension of the file standard are not limited to these examples.

In this set file, for example, as shown in an enlarged view of the file 1, one top image data and the subsequent image data, which corresponds to images 2 to m, are contained. Each image data is made up of SOI that is a marker indicating the top of data, the marker segment APP1 in which the same data as described above is recorded, a marker segment APP2 in which auxiliary sample format information defined in a sample format is recorded, the main body of the image data encoded in a JPEG format, and EOI that is a marker indicating the end of the data. In the marker segment APP2 of the top image data, the number of contained images that represents the number of images contained in the set file, the image type, the size of each image, the data format of each image data, such as JPEG and TIFF (JPEG in this embodiment), an offset for SOI of each dependent image data from a given point (P0 in FIG. 2) in the marker segment APP2 as the origin, and so on are recorded. In the marker segment APP2 of the subsequent image data, image numbers 2, 3, . . . , m and other information are recorded. The image type mentioned above represents the relation of the plurality of pieces of contained image data. For example, when image data for panoramic composition obtained by panoramic-image capturing as described above is contained in the form of a plurality of pieces of image data, the image type is recorded as “panoramic composition”. When image data for monitor displaying that is obtained by resizing the top image data for the purpose of monitoring is contained, the image type is recorded as “monitor display”. Note that in the offset of each image, the given position P0 in the marker segment APP2 is used as the origin; however, the origin is not limited to this. The origin may be the heading positions of the marker segments APP1 and APP2 and the like, and may also be a given position in the marker segment APP1. Here, the top image data contained in the set file can be accessed as in the case of image data contained in a typical file, such as the file 2, and the subsequent image data can be accessed using an offset recorded in the marker segment APP2 of the top image data. Note that the marker segments APP1 and APP2 correspond to headers of image data.

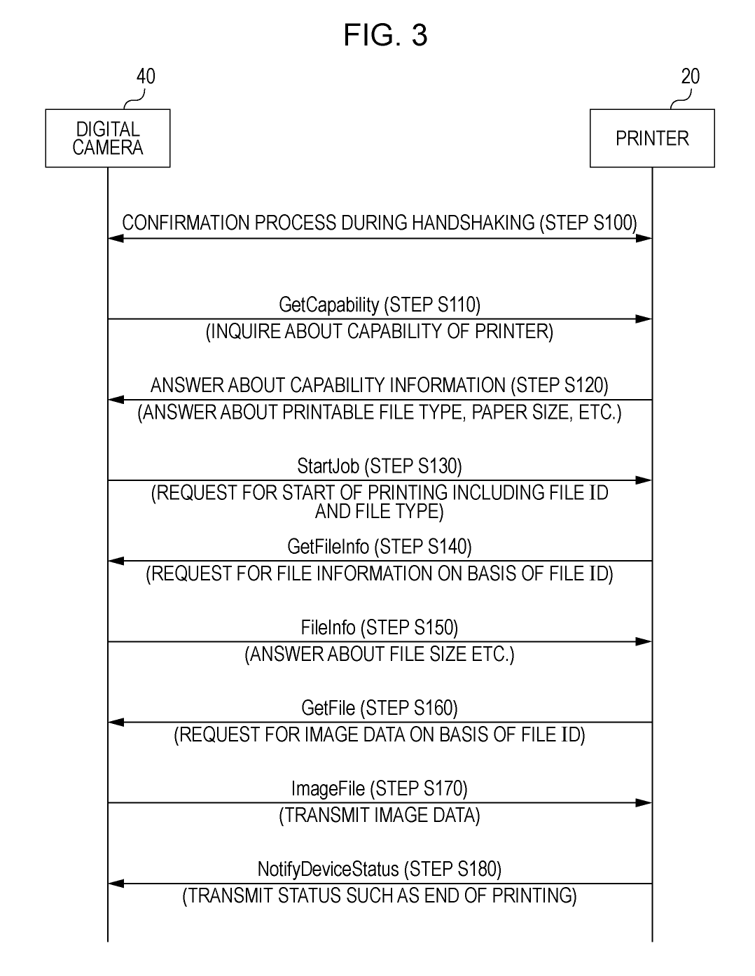

Next, the operation of the printer 20 and the digital camera 40 when direct printing using PictBridge is performed in the printing system 10 configured as described above is described. First, the schematic communication procedures when performing the direct printing are described, and then the details of the operation of the digital camera 40 are described. FIG. 3 is a sequence view schematically showing the communication procedures. The communication procedures are performed when connection between the printer 20 and the digital camera 40 is established via the USB cable 32. Note that in FIG. 3, the details of processing in the case where the image file stored in the flash memory 45 of the digital camera 40 is a set file are omitted for purposes of schematic explanation of the communication procedures.

In the communication procedures, first, a confirmation process during handshaking is performed. In the confirmation process, it is confirmed whether or not the printer 20 (the controller 21) and the digital camera 40 (the controller 41) are in conformity with direct print system (DPS) specifications, and if they are in conformity with the specifications, then what service functions (e.g., a print server function and a print client function) they have is confirmed (step S100). When the confirmation process has been performed, the digital camera 40 transmits a “GetCapability” command for inquiring about, for example, a printable data format (such as JPEG or TIFF) and a paper size (such as an A4 size or a photograph size L) as the capability of the printer 20 (step S110), and receives transmission of an answer about the Capability information from the printer 20 (step S120). Next, the digital camera 40 displays image data contained in an image file stored in the flash memory 45 on the operation panel 46 such that the image data can be selected, which is not shown, and accepts selection of image data to be printed and setting of various printing conditions that are performed by a user. When the user's selection of setting is accepted, “StartJob” that is a command requesting start of printing is transmitted (step S130).

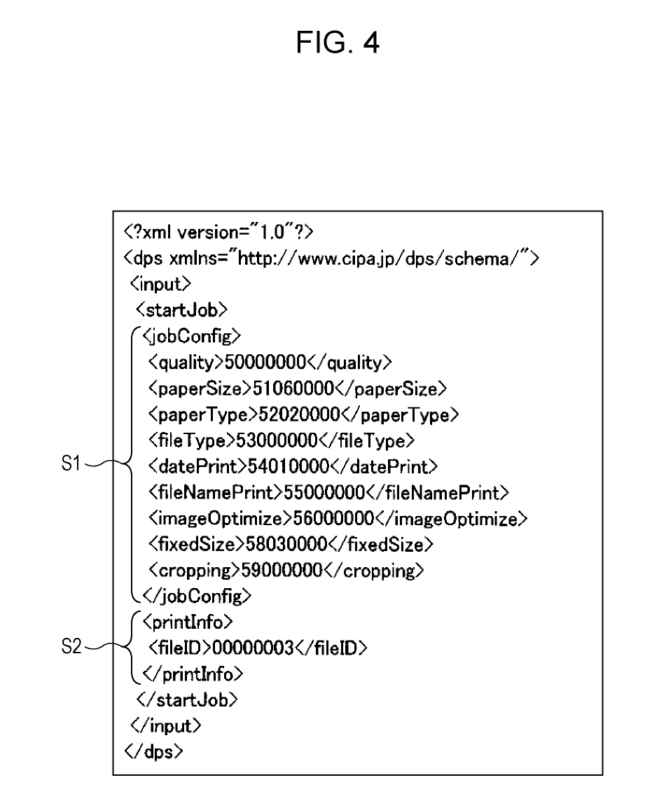

An example of the “StartJob” command transmitted at this point is shown in FIG. 4. As shown, the “StartJob” command is made up of <jobConfig> (S1) showing the structure of a printing job that reflects the setting of various printing conditions, and <printInfo> (S2) showing information that specifies image data to be printed. In <jobConfig>, image quality <quality> such as standard image quality or high image quality, a paper size <paperSize> such as an A4 size or a photograph size L, a paper type <paperType> such as plain paper or photograph paper, a data format <fileType> of an image file, whether or not to perform date printing <datePrint>, whether or not to perform file name printing <fileNamePrint>, whether or not to optimize an image <imageOptimize>, whether or not to perform printing in a fixed-size <fixedSize>, and whether or not to print a chosen area of an image <cropping> are each specified. In <printInfo>, a file ID <fileID> is specified. Upon receiving a “StartJob” command as mentioned above, the printer 20 transmits a “GetFileInfo” command that makes a request for file information, such as a file size, on the basis of a file ID included in the “StartJob” command (step S140). The “GetFileInfo” command, which is not shown, is created in the format including the file ID.

Upon receiving the “GetFileInfo” command, the digital camera 40 accesses an image file on the basis of the file ID and reads out the requested information from the header, and transmits the information as a “FileInfo” command (step S150). Upon receiving the “FileInfo” command, the printer 20 transmits a “GetFile” command that makes a request for image data to be printed on the basis of the file ID if the printer 20 determines that a printing process can be performed, on the basis of information, such as a file size and the status of a print buffer area (not shown) of the RAM 24 (step S160). The “GetFile” command is also created in a form including a file ID, which is not shown. Upon receiving the “GetFile” command, the digital camera 40 accesses an image file on the basis of its file ID and reads image data, and transmits the read image data together with an “ImageFile” command to the printer 20 (step S170). Upon receiving the image data in this way, the printer 20 converts the received image data into data for printing and performs printing on the sheet of recording paper S. Note that when JPEG data is specified in <fileType> of the “StartJob” command, the received image data is JPEG data, and therefore a process of converting the JPEG data into data for printing that can be printed by the printing mechanism 26 is performed. Upon performing printing, the printer 20 transmits to the digital camera 40 a “NotifyDeviceStatus” command that notifies the digital camera 40 of the status of the printer 20 such as the end of printing (step S180). Note that in cases where a plurality of pieces of image data are selected by a user, processing of steps S130 to S180 is repeatedly performed.

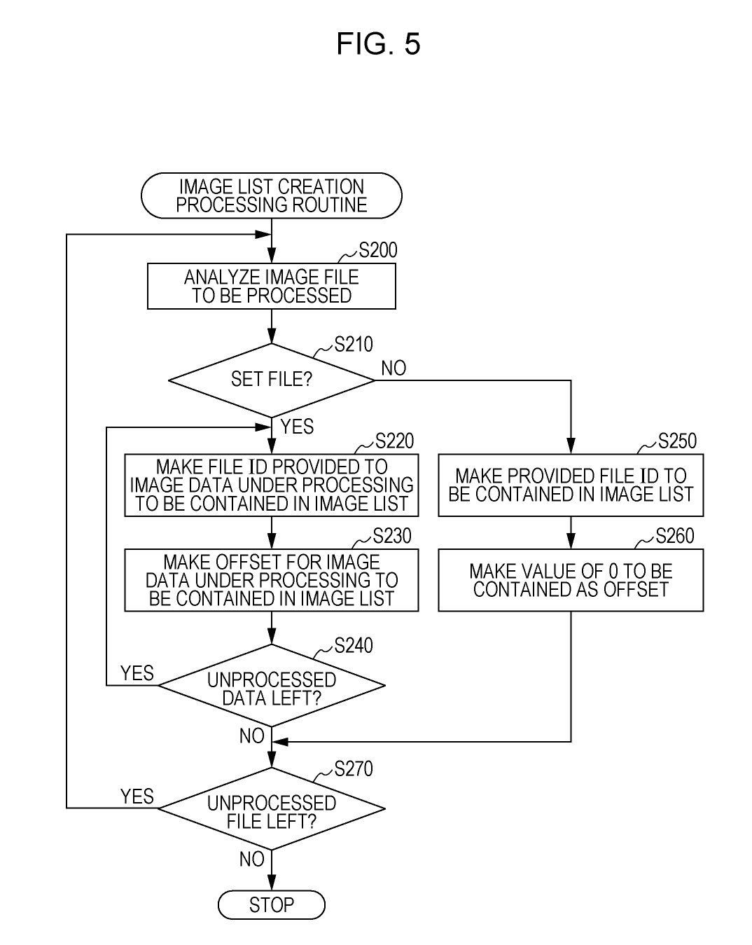

Next, regarding the details of operation of the digital camera 40 in direct printing using PictBridge under the communication procedures, the case of storing a typical file and a set file in the flash memory 45 is described. FIG. 5 is a flow chart showing an example of an image list creation processing routine performed by the controller 41 of the digital camera 40. This routine is executed when the confirmation processing in step S100 of the communication procedures of FIG. 3 is performed. Note that an image list is created in a list creation area (not shown) of the RAM 44.

When execution of the image list creation processing routine starts, the CPU 42 of the controller 41 analyzes an image file to be processed in the stored image file in the flash memory 45 (step S200). Note that the image file to be processed is selected in the order starting from the file 1. Here, as analysis of an image file, for example, processing is performed such that a file name and an extension are acquired, it is determined from the acquired extension whether the image file is a typical file or a set file, and if the image file is a set file, then the marker segment APP2 is analyzed so as to read out information such as an offset. As a result of analyzing the image file, if the image file is determined to be a set file (step S210), a file ID is provided to the image data being processed, and the provided file ID is made to be contained in an image list (step S220). The offset for the image data being processed is made to be contained in the image list (step S230). Here, the file ID corresponds to the image ID of some aspects of the invention, and in this embodiment, a serial number for identifying each piece of image data is provided sequentially from a value of 3. Note that the serial number is not limited to one starting from the value of 3, but may be one starting from any value, such as one starting from a value of 1. The image data to be processed is selected sequentially from an image number 1. This containing processing is repeatedly performed until image data that has not been processed is not left in the set file (step S240). On the other hand, if the image file is determined to be not a set file in step S210, that is, if the image file to be processed is a typical file, a file ID is provided to the image file, and the provided file ID is made to be contained in the image list (step S250), and a value of 0 is made to be contained as the offset in the image list because the offset is not stored in the image file (step S260). Note that the file ID provided at this point is a serial number, which is not different from the file ID provided in step S220. During processing of the set file, if it is determined in step S240 that image data that has not been processed is not left, or if processing of a typical file has been performed, then it is determined whether or not an image file that has not been processed is left in the flash memory 45 (step S270). If an image file that has not been processed is left, then processing in and after step S200 is repeated, whereas if the image file that has not been processed is not left, this routine stops.

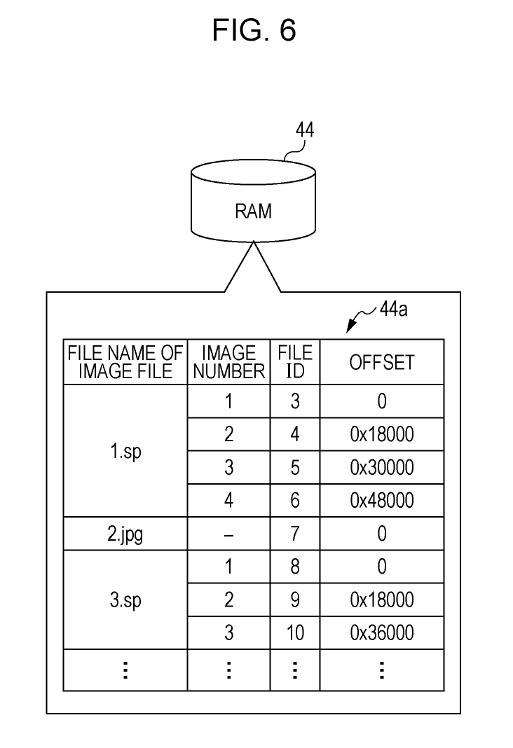

The image list created by the image list creation processing routine is described below. FIG. 6 is an explanatory view showing an example of an image list 44a created in the list creation area of the RAM 44. As shown, in the image list 44a, the file name of each image file, the image number of each image data contained in the image file, the file ID provided to each image data, and the offset for each image data are contained. The file ID provided as the serial number is contained as described above. Therefore, using the file ID, each image data can be individually identified even if it is contained in a set file. For the image data designated by the image number 2 and the subsequent image numbers of the set file, offsets for them are contained in the list. Therefore, using offsets contained in the image list 44a, image data can be accessed.

Here, a description is given of the data format <fileType> and the file ID<fileID> contained in the “StartJob” command in step S130 in the above-described communication procedures of FIG. 3 in cases where image data in a set file is selected by a user. Upon selection of image data in a set file, the CPU 42 of the controller 41 acquires a file ID associated with the image data selected from the image list 44a based on the selected image file name and image number. Then, the selected file ID is specified as the <fileID> of the “StartJob” command. Thus, the file ID associated with each image data can be contained in the “StartJob” command even if image data contained in a set file is specified by a user. Accordingly, it is possible to identify image data and a set file with a print instruction. Regarding the data format <fileType>, the data format of each image data recorded in the marker segment APP2 is specified as the <fileID> of the “StartJob” command. This enables each image data to be printed by the printer 20 if the image data can be handled by the printer 20 even when the printer 20 does not support a set file. Note that for example, if image data of an image number 3 of the file 1 is selected by a user, its file ID is provided with a value of 5, and therefore the <fileID> in FIG. 4 is specified as “00000005”.

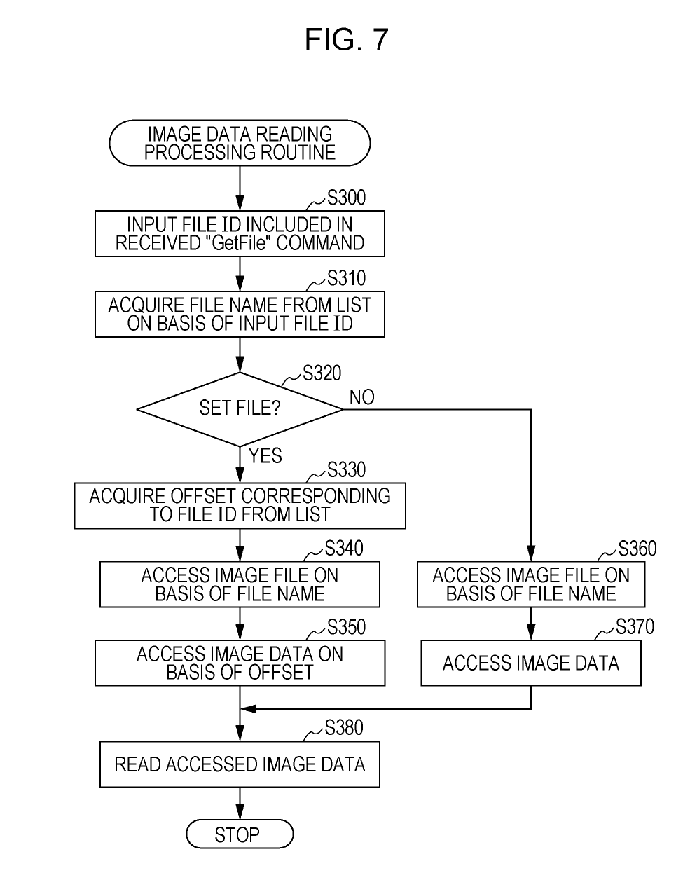

Next, a description is given of processing after the image list 44a is created and the “StartJob” command is transmitted. As an example, a description is given of the operation when the controller 41 of the digital camera 40 accesses an image file and reads image data on the basis of the file ID upon receiving the “GetFile” command of step S160 in the communication procedures of FIG. 3. FIG. 7 is a flow chart showing an example of an image data reading processing routine. When execution of this image data reading processing routine starts, first, the CPU 42 of the controller 41 inputs a file ID included in the received “GetFile” command (step S300), the file name of the image file is acquired by referring to the image list 44a on the basis of the input file ID (step S310). When the file name is acquired, it is determined from its extension whether or not the image file is a set file (step S320). If the image file is a set file, an offset corresponding to the file ID is acquired from the image list 44a (step S330). On the basis of the acquired file name, an image file in the flash memory 45 is accessed (step S340), and on the basis of the acquired offset, a read pointer is moved by an amount corresponding to the offset from the origin position P0 of the offset in the marker segment APP2 to access image data in the image file (step S350). Then, the accessed image data is read (step S380), and this routine stops. In this way, when a file ID is provided, an offset for the corresponding image data as well as an image file name can be acquired by referring to the image list 44a, and therefore image data can be smoothly accessed even if it is stored in a set file. The offset is acquired from the image list 44a without analyzing the marker segment APP2 every time the image data is accessed. This makes rapid access possible.

Note that in step S320, if it is determined that the image file is not a set file, that is, it is a typical file, a typical data access processing is performed without acquiring an offset. More specifically, an image file in the flash memory 45 is accessed on the basis of the acquired file name (step S360), and image data is accessed (step S370). In step S380, the accessed image data is read, and then this routine stops. The image data read in this routine in this way is transmitted to the printer 20 in transmission processing of the “ImageFile” command of step S170 in the communication procedures of FIG. 3. Note that likewise, an image file and image data can be accessed using a file ID as the key upon receiving the “GetFileInfo” command of step S140 in the communication procedures of FIG. 3. As described above, even if image data selected by a user is image data contained in a set file, a file ID associated with the selected image data acquired by referring to the image list 44a is transmitted such that the file ID is included in the “StartJob” command. As a result, in the following processing, an image file name and an offset are acquired from the image list 44a by using as a key the file ID included in each command to access image data. Therefore, even if image data contained in a set file is selected, the image data can be printed the same as image data contained in a typical file by the printer 20 without any change or any addition to the communication procedures in PictBridge and a transmitted content. Even if the printer 20 does not support the data format of a set file, image data in the set file can be printed.

Here, in stead of creating the image list 44a when direct printing using PictBridge is performed, it is conceivable that each image data contained in a set file is individually separated and the separated image data is individually contained in an individual image file. However, in this case, the separating processing takes much time depending on the number of set files and the amount of contained image data. This causes interruption of smooth printing processing. To save the separated individual image file, a memory area larger than a list creation area needs to be secured. However, in the digital camera 40 for which compactness is demanded, a large memory area cannot be secured in some cases. From these reasons, it is desirable that processing as in this embodiment be performed.

Here, the corresponding relationship between elements in this embodiment and elements of some aspects of the invention are clarified. The flash memory 45 of this embodiment corresponds to a “storage medium” of some aspects of the invention, the digital camera 40 corresponds to a “print instruction apparatus”, and the printer 20 corresponds to a “printing device”.

According to the digital camera 40 of this embodiment described in detail above, when direct printing using a communication standard of PictBridge is performed, a file ID for identifying each image data is set, and the image list 44a in which the set file ID and an offset are contained so as to be associated with each other is created. Upon acceptance of a user's selection of image data, a file ID is acquired from the image list 44a, and the file ID included in a command requesting start of printing is transmitted to the printer 20. Upon receiving a request command for image data corresponding to the file ID, an image file name and an offset corresponding to the file ID are acquired from the image list 44a, and the image data is read and transmitted to the printer 20. Therefore, exchanges of commands and image data in conformity with a communication standard can be performed between the printer 20 and the digital camera 40 using the file ID set in each image data. Since the offset associated with the image ID is contained in the image list 44a, image data can be smoothly accessed without acquiring the offset by analyzing a set file upon every access. As a result, a plurality of pieces of image data that are related to one another are collectively managed, and a print instruction in conformity with a communication standard is performed, thereby enabling smooth printing.

It should be understood that the invention is not limited to the foregoing embodiment, and may be implemented in various forms within the technical scope of the invention.

While the image list 44a is created in the RAM 44 in the foregoing embodiment, the image list 44a is not limited to this and may be created in the flash memory 45.

While whether or not a file in which image data selected by a user is contained is a set file is determined in the image data reading processing routine shown in FIG. 7 in the foregoing embodiment, this determination may be omitted. In this case, even if the file is a typical file, image data may be accessed by acquiring a value of 0, as an offset corresponding to the file ID, from a list.

In the foregoing embodiment, the offset for each image data from the given position P0 as the origin is contained in the marker segment APP2 of a set file, and this offset is contained in an image list without any change. However, the offset may be converted into an offset from the starting address of image data, and the resultant offset may be contained in the image list. For example, if an offset at the given position P0 from the starting address has a value of a, a value obtained by adding the value of a to the offset for each image data may be contained as an offset in the image list.

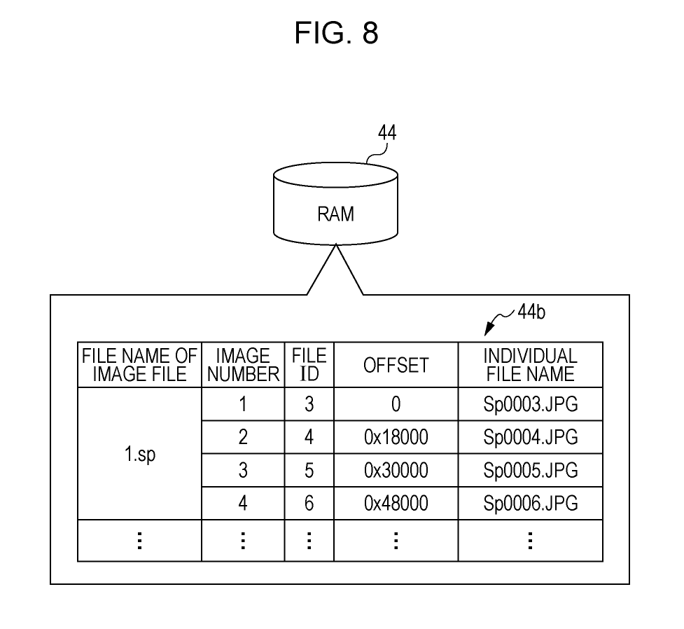

In the foregoing embodiment, file names of image files, image numbers, file IDs and offsets are contained in the image list 44a. However, in addition to them, the name of each image data in a set file may be created as an individual file name and be contained in the image list. An example of the image list 44b in this case is shown in FIG. 8. As shown, individual file names in which the numbers of the file IDs are cited and that are provided with extensions on the basis of data formats of image data are contained. Although each image data contained in a set file does not have the designation of a file, an individual file name created in this way is contained in an image list, thereby enabling the individual file name to be printed, for example, as the designation of a file when an image is printed.

While direct printing using PictBridge has been described in the foregoing embodiment, direct printing is not limited to this and may be printed using a digital print order format (DPOF). The DPOF as used herein, the detailed description of which is omitted, is a format that allows automatic printing by creating an automatic print file in which information for identifying an image file to be printed among image files stored in the flash memory 45 of the digital camera 40, setting information on image printing, and the like are described in a text format, and by transmitting the automatic print file as a job to the printer 20. In the automatic print file, pass information of an image file to be printed is required as information for identifying the image file. Therefore, when it is instructed that image data in a set file be printed in DPOF, the file name of each piece of image data is required for setting pass information. At this point, as exemplified in the image list 44b of FIG. 8, an individual file name of each piece of image data in the set file is contained in the image list, so that the required pass information can be set. If the set pass information is contained in the image list so as to be associated with an offset, image data of the set file can be read by acquiring the offset from the image list when the pass information is specified. This enables handling in conformity with a standard of DPOF even in the case of instructing that image data in a set file be printed in DPOF.

In the foregoing embodiment, the image list creation processing routine is executed when confirmation processing of communication procedures is performed. However, the image list creation processing routine is not limited to this, but may be executed at a timing before a “StartJob” command is transmitted, such as the timing of creating the “StartJob” command.

In the foregoing embodiment, image data is encoded in a JPEG format. However, image data is not limited to this, but may be encoded in other formats, such as Windows device independent bitmap (BMP), graphics interchange format (GIF) and tagged image file format (TIFF), that can be handled by the printer 20.

In the foregoing embodiment, recording an offset for each image in the marker segment APP2 is exemplified. However, the offset may be recorded in any marker segment APPn (n is any integer).

What is claimed is:

1. A print instruction apparatus that is connected to a storage medium where an image file having image data contained therein is stored, and that instructs a printing device to print an image selected by a user using a given communication standard, wherein
when a set file in which directly accessible top image data and subsequent image data are contained is stored in the storage medium, the subsequent image data being accessible at an address determined with an offset from a given position of the top image data as an origin, the offset being registered in a header of the top image data, an image ID configured to individually identify each piece of image data contained in the set file is set by analyzing the set file, and a list in which the set image ID and positional information based on the registered offset for reading corresponding image data are contained so as to be associated with each other is created;
when selection by a user of image data contained in the set file is accepted, an image ID set for the image data of the selection is acquired from the created list, and the acquired image ID is transmitted to the printing device, the acquired image ID being included in a command requesting start of printing; and
when a command requesting output of image data corresponding to the image ID is received from the printing device that has received the command requesting start of printing, the positional information based on the offset that is associated with the image ID is acquired from the created list, and on a basis of the acquired positional information, the corresponding image data is read from the stored set file and is transmitted together with a data transmission command to the printing device.

2. The print instruction apparatus according to claim 1, wherein the offset from the given position is converted to an offset from a starting address of the top image data and is contained in the list.

3. The print instruction apparatus according to claim 1, wherein
the set file is a file in which a data format for every piece of image data contained in the image file is registered in the header of the top image data, and
when the selection by the user of image data contained in the set file is accepted, the header of the top image data of the set file is analyzed, and a data format of the image data whose selection is accepted is transmitted, the data format being included in the command requesting start of printing.

4. The print instruction apparatus according to claim 1, wherein the list is created when establishment of communication is confirmed.

5. The print instruction apparatus according to claim 1, wherein the given communication standard is PictBridge.

6. A printing system comprising:
a print instruction apparatus that is connected to a storage medium where an image file having image data contained therein is stored, and that instructs printing of an image selected by a user; and
a printing device that accepts image data from the print instruction apparatus and prints an image, the printing device and the print instruction apparatus being connected so as to be able to communicate with each other using a given communication standard,
the print instruction apparatus, wherein
when a set file in which directly accessible top image data and subsequent image data are contained is stored in the storage medium, the subsequent image data being accessible at an address determined with an offset from a given position of the top image data as an origin, the offset being registered in a header of the top image data, an image ID configured to individually identify each piece of image data contained in the set file is set by analyzing the set file, and the list in which the set image ID and positional information based on the registered offset for reading corresponding image data are contained so as to be associated with each other is created;
when selection by a user of image data contained in the set file is accepted, an image ID set for the image data of the selection is acquired from the created list, and the acquired image ID is transmitted to the printing device, the acquired image ID being included in a command requesting start of printing; and
when a command requesting output of image data corresponding to the image ID is received from the printing device that has received the command requesting start of printing, the positional information based on the offset that is associated with the image ID is acquired from the created list, and on a basis of the acquired positional information, the corresponding image data is read from the stored set file and is transmitted together with a data transmission command to the printing device.
